(19) United States
(12) Patent Application Publication
(10) Pub. No.: US 2023/0186169 A1
(43) Pub. Date: Jun. 15, 2023

(54) ACID CORROSION INHIBITOR VIRTUAL LABORATORY

(71) Applicant: Saudi Arabian Oil Company, Dhahran (SA)

(72) Inventor: Nasser Mubarak Al Hajri, Abqaiq (SA)

(21) Appl. No.: 17/548,977

(22) Filed: Dec. 13, 2021

(51) Int. Cl. G06N 20/20

(52) U.S. Cl. CPC G06N 20/20

(57) ABSTRACT

A system and method an acid corrosion inhibitor virtual laboratory is described. The method includes obtaining inputs comprising at least one of an acid concentration, exposure time, temperature, or any combinations thereof. A success or failure of a predefined minimum inhibitor loading value is predicted. A minimum inhibitor loading value that is a successful corrosion inhibitor loading is determined based on the inputs responsive to a failure of the predefined minimum inhibitor loading value.

### TECHNICAL FIELD

This disclosure relates to acid corrosion inhibitors.

### BACKGROUND

In the petroleum industry, stimulation treatments with acid are an established method to increase well production rates by dissolving fines and/or removing formation damage. Either organic acids such as citric/acetic acids or mineral acids such as hydrochloric acid (HCl)/hydrofluoric acid (HF) are injected into the well at high concentrations. These treating acids are corrosive in nature.

### SUMMARY

An embodiment described herein provides a method. The method enables an acid corrosion inhibitor virtual laboratory. The method includes obtaining inputs comprising at least one of an acid concentration, exposure time, temperature, or any combinations thereof and predicting a success or failure of a predefined minimum inhibitor loading value. The method includes determining a minimum inhibitor loading value that is a successful corrosion inhibitor loading based on the inputs responsive to a failure of the predefined minimum inhibitor loading value.

Another embodiment described herein provides a system that includes at least one processor and at least one non-transitory storage media storing instructions that, when executed by the at least one processor, cause the at least one processor to perform operations. The operations include obtaining inputs comprising at least one of an acid concentration, exposure time, temperature, or any combinations thereof and predicting a success or failure of a predefined minimum inhibitor loading value. The operations include determining a minimum inhibitor loading value that is a successful corrosion inhibitor loading based on the inputs responsive to a failure of the predefined minimum inhibitor loading value.

Another embodiment described herein provides at least one non-transitory storage media storing instructions that, when executed by at least one processor, cause the at least one processor to perform operations. The operations include obtaining inputs comprising at least one of an acid concentration, exposure time, temperature, or any combinations thereof and predicting a success or failure of a predefined minimum inhibitor loading value. The operations include determining a minimum inhibitor loading value that is a successful corrosion inhibitor loading based on the inputs responsive to a failure of the predefined minimum inhibitor loading value.

### BRIEF DESCRIPTION OF DRAWINGS

FIG. 1 is an illustration of a machine learning model.

FIG. 2 is a confusion matrix.

FIG. 3 is an illustration of confidences and ranges.

FIG. 4 is a process flow diagram of a process for iteratively determining corrosion inhibitor loading based on a predefined minimum corrosion inhibitor loading value.

FIG. 5 is a process flow diagram of a process for iteratively determining corrosion inhibitor loading using statistically significant generated data.

FIG. 6 is a process flow diagram of a process for an acid corrosion inhibitor virtual laboratory.

FIG. 7 is a block diagram of a system used for an acid corrosion inhibitor virtual laboratory

### DETAILED DESCRIPTION

Embodiments described herein provide an acid corrosion inhibitor virtual laboratory. In the absence of corrosion inhibitors, the generalized corrosion rate of the steel exposed to acid increases exponentially with acid concentration and temperature. This can be reduced to an acceptable level by adding appropriate concentrations of corrosion inhibitor products in order to protect and prolong the useful lifetime of steel exposed to acid which include coiled tubing (used for acid conveyance) and downhole well components (casing and tubulars). Generally, corrosion inhibitors demonstrate high efficiency in providing corrosion protection at temperatures below 150° C. Corrosion inhibitors are included in acid recipes, the first inhibitors used were arsenic acids but were replaced by organic corrosion inhibitors mainly due to the toxicity of arsenic acids and their harmful environmental impact.

There are various methods used to test the effectiveness of a corrosion inhibitor when used with an acid recipe. Explanation of two methods used to test a corrosion inhibitor performance is presented below. The tests include an autoclave test and an electrochemical analysis.

Generally, the autoclave test is used for testing corrosion inhibitor performance. It uses weight loss analysis as the basis for qualifying a corrosion inhibitor. Metal coupons representing field conditions (either a coiled tubing or a downhole completion pipe) are used in the autoclave. The preparation of test coupons is done carefully since it can result in different corrosion rates in the tests. The weights of the metal coupons are measured before and after the autoclave test to quantify the metal loss. The autoclave device subjects the metal coupons to pressures and temperatures simulating an acid treatment with the exact same acid recipe (including corrosion inhibitor) and exposure time planned for the field job. The weight loss after the test per surface area is calculated and it has to be lower than a pre-determined cutoff in order to qualify the corrosion inhibitor safe for field deployment. Conventionally, the acceptable weigh loss for coiled tubing pipes is 0.02 lb/ft2 and for downhole casing pipe is 0.05 lb/ft2. The metal loss of the analysis is affected by the acid volume/steel-area ratio.

Electrochemical analysis is used to test a corrosion inhibitor performance. In electrochemical analysis, electrochemical measurements are carried out using an electrode cell arrangement. The test utilizes a steel disc as an electrode which is once immersed in an acid solution without the inhibitor and in another test it is immersed in the acid solution with the corrosion inhibitor. This process includes building Tafel curves using the measurements of the test and then extrapolating the Tafel slope to obtain the corrosion potential. Finally corrosion rate and inhibitor efficiency can be calculated against pre-determined acceptable values.

Typically, petroleum production engineers rely on the autoclave tests to identify the appropriate corrosion inhibitor loading (in gallons per thousand gallons, gpt). Given that the cost of a corrosion inhibitor is high, practicing production engineers use a minimum corrosion inhibitor loading that satisfy the acceptable weight loss (0.02 lb/ft2 in coiled tubing or 0.05 lb/ft2 in casing pipe). To achieve this objective, engineers either need to conduct an autoclave test for each stimulation job or reference a past autoclave test with similar conditions (temperature, exposure time, acid strength, etc), which could overestimate the required corrosion inhibitor value. In the present techniques, an alternative methodology is presented to obtain the minimum acceptable corrosion inhibitor loading using a virtual laboratory developed via machine learning models.

In embodiments, the present techniques enable a machine learning virtual laboratory that simulates autoclave testing to provide an optimum loading for acid corrosion inhibitors used in stimulation jobs. Generally, the optimum loading for an acid corrosion inhibitor provides the lowest acceptable/safe chemical loading to lower the cost of the acid recipe. In embodiments, training data includes hundreds of past autoclave tests representing a wide range of conditions.

Hundreds of past autoclave tests have been collected representing a wide range of test conditions. Several machine learning models are trained on these test points and later used to predict the optimum corrosion inhibitor loading. A virtual laboratory is based on the best preforming machine learning model. The virtual laboratory provides guidance to field engineers on the right level of inhibitor concentration at the lowest incurred cost.

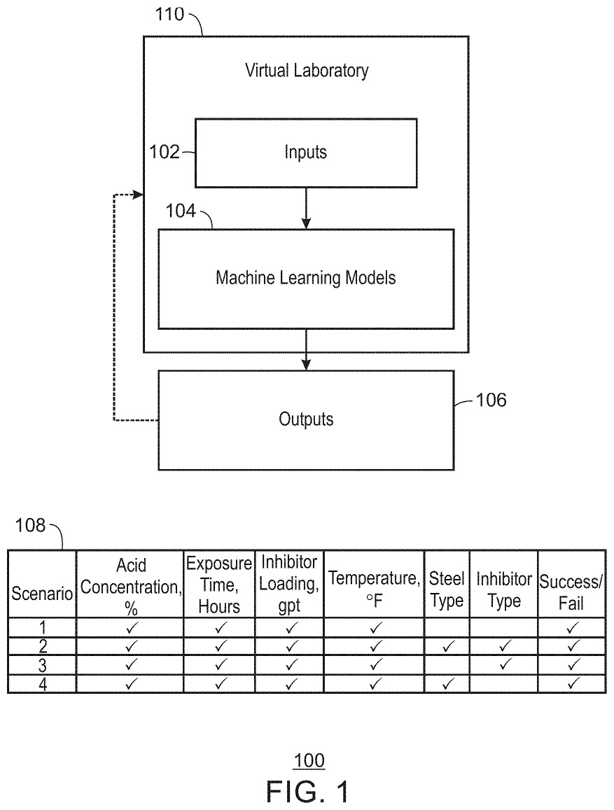

FIG. 1 is an illustration of a machine learning model. In embodiments, the acid corrosion inhibitor virtual laboratory uses an underlying dynamic machine learning model that can be continuously updated with actual, real-world, physical autoclave laboratory tests results. A group of inputs 102 that are passed to the machine learning model 104 and provide an inhibitor loading as an output 106.

In examples, the machine learning training process is as follows. The process of actual laboratory autoclave testing involves testing with metal coupons that consist of different steel types with an acid recipe. The autoclave lab test measures the weight loss per unit area as a result. The testing conditions vary, and these conditions include: 1) Expected steel exposure time to acid; 2) Acid strength or concentration percentage; 3) Maximum expected downhole temperature; 4) Type of corrosion inhibitor used in the acid recipe; 5) Different corrosion inhibitor loadings; and 6) Steel type being used in the stimulation.

Several past laboratory tests are conducted representing wide range of the above listed conditions. The lab tests are divided into two datasets. One dataset is comprised of 80% of the complete autoclave tests and is provided as an input to the machine learning model for training. The remaining 20% is used a testing dataset. The testing dataset is used to verify the confidence of machine learning model predictions. Generally, the autoclave data set obtained via the lab tests for machine learning is selected for typical oil and water wells acid stimulation conditions. The selection mainly involves the temperature range, type of steel, and use of a corrosion inhibitor without an intensifier.

Several machine learning models 104 are used on the same datasets for training and testing purposes. The machine learning model that provides the highest confidence can be used by field engineers to design acid stimulation recipes, at acceptable corrosion metal loss and lowest cost. The model can be dynamic, with new tests uploaded to the model to continuously train and increase the prediction confidence. After a machine learning model with the highest confidence is selected, are the other remaining machine learning are executed again if new data is available.

In examples, the machine learning model is a dynamic machine learning model with periodic updates. The machine learning model is iteratively trained with additional training data. As the number of known scenarios increase, a prediction confidence in the machine learning model increases.

The initial data generated for training and testing included over 450 tests to be widely representative and make the model ready for industrial application. In embodiments, additional data feeds are used to fine-tune the machine learning models. In particular, weights of the machine learning models are updated for improvement or fine tuning of prediction capabilities. Thus, the model can be described as dynamic.

As a starting point for training the machine learning model, four training/testing scenarios are used. An input set for each scenario is illustrated in the table 108 of FIG. 1. In the outputs 106, an autoclave test success is denoted as 1 in the machine learning training and testing, while an autoclave test failure is denoted as 0. Success and failure criteria follow the conventional acceptable metal loss in weight pound per square feet (lb/ft2). The rationale of training and testing on four different scenarios is to study the sensitivity of autoclave testing data to the steel and inhibitor types. Thus, in embodiments, the scenarios used to train the machine learning model define the inputs to the machine learning model during operation. Inputs such as steel and inhibitor types can vary based on the contractor being used to conduct acid stimulation, while other parameters which are temperature, exposure time, and acid concentrations are dependent on oilfield operator's well conditions. In embodiments, other inputs are varied/manipulated to train a model that is sensitive to the other inputs (acid concentration, exposure time, inhibitor loading, temperature). Accordingly, the other inputs can be used and varied in other applications of the machine learning models.

Eight machine learning models 104 are trained and then tested for confidence. Each and every model is used with the four input scenarios. Accordingly, 32 machine learning models are developed for evaluation according to the present techniques. The eight machine models include K-nearest neighbor, gradient boosting classifier, logistic regression, support vector machine, linear support vector classifier, random forest classifier, decision tree, and neural network.

K-Nearest Neighbor is a supervised machine learning algorithm that can be used to solve both classification and regression problems. The algorithm assumes that similar things exist in close proximity. The gradient boosting classifier is a machine learning technique used for regression and classification. It produces a prediction model in the form of an ensemble of weak prediction models, typically decision trees.

Logistic regression is a machine learning algorithm that uses the logistic function also called as the sigmoid function for binary classification problems (problems with two class values). It is linear, however the predictions are transformed using a logistic function. A support vector machine (SVM) is a linear model for classification and regression problems. It can solve both linear and non-linear problems. In operation, the SVM creates a line or a hyperplane which separates the data into classes. The linear support vector classifier is similar to SVM but has more flexibility and can scale better to a large number of data points.

A random forest classifier is a supervised learning algorithm that builds an ensemble of decision trees and merges them together to get a more accurate and stable prediction. It can be used for both classification and regression problems. A decision tree algorithm is a supervised learning algorithm, and can be used to solve regression and classification problems. A decision tree creates a training model that can be used to predict a class or value of the target variable by learning simple decision rules inferred from training dataset. A neural network algorithm can be used for both classification and regression problems. The process of creating a neural network begins with the perceptron. The perceptron receives inputs, multiplies them by some weights, and then passes them into an activation function to produce an output.

To test the machine learning models 104, each respective model obtains inputs associated with each scenario, which are all data except for success/failure (1/0) labels used to predict if the weight loss test is a success or failure in terms of weight loss per unit area (lb/ft²). Two metrics are introduced to evaluate every model and input scenario, they are the confusion matrix and confidence score.

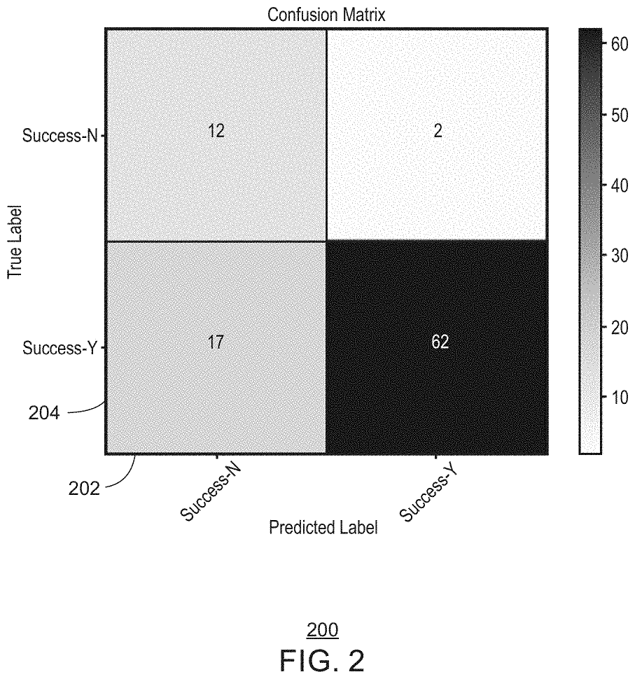

FIG. 2 is a confusion matrix 200. The confusion matrix 200 describes the numerical quantification of the model's inhibitor loading output (confidence). The confusion matrix is a quality check associated with each respective machine learning model. The X-axis 202 represents the machine learning model prediction while the Yaxis 204 represents the actual success or failure of the autoclave test. The confidence of the machine learning model is quantified using the below equation:

$$Confidence = \frac{{P}_{1} + {P}_{2} + {P}_{3}}{{P}_{1} + {P}_{2} + {P}_{3} + {P}_{4}}$$

Where:

P₁=Number of Tests predicted as a success by the machine learning model AND are successful in the autoclave lab test;

P₂=Number of Tests predicted as a failure by the machine learning model AND that failed in the autoclave lab test;

P₃=Number of Tests predicted as a failure by the machine learning model AND are successful in the autoclave lab test; and

P₄=Number of Tests predicted as a success by the machine learning model AND that failed in the autoclave test.

It is intuitive to quantify the confidence (accuracy) of the machine learning model in the cases where the model has agreed with actual autoclave laboratory tests (datasets in P₁ & P₂ categories). The quantified confidence of the tested machine learning models has also included datasets in P₃ category where the machine learning model predicted a failure, while the actual autoclave laboratory test is successful. The rationale behind adding the datasets of P₃ category, is that the resulting model will increase the chemical loading (minor addition to cost) while the reliability of the steel coupon is still maintained within the acceptable metal loss range. Accordingly, the essence of performing the acid stimulation within safe and acceptable corrosion limits are still honored without loss of confidence.

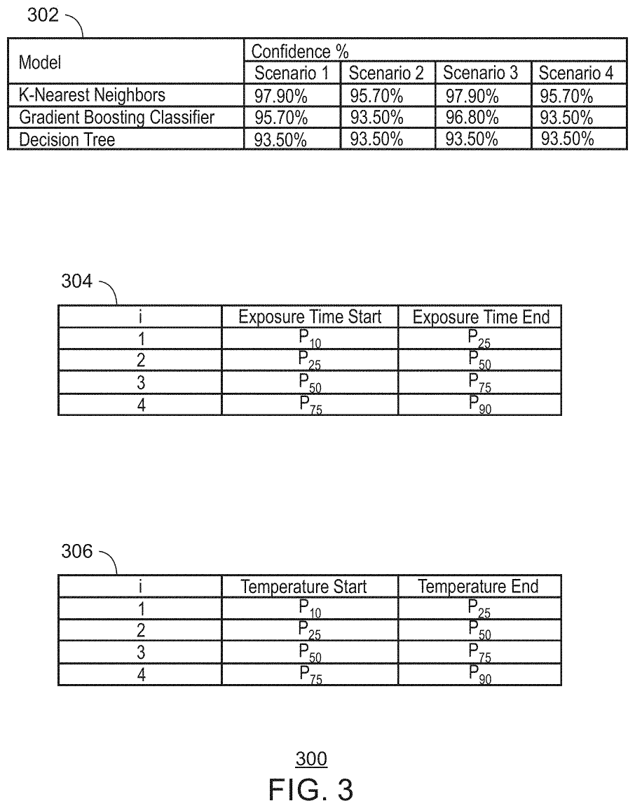

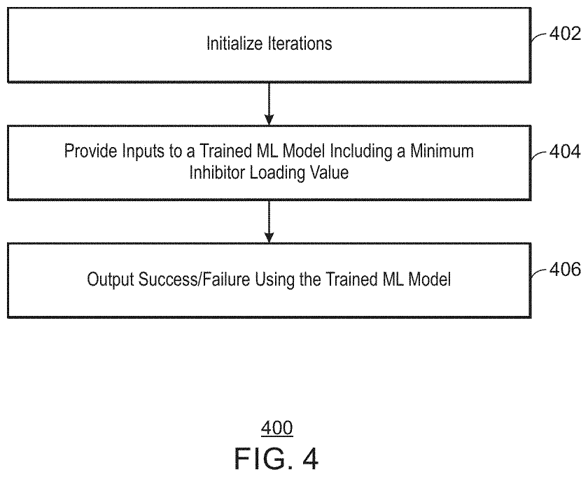

FIG. 3 is an illustration of confidences and ranges associated with FIGS. 4-6. In FIG. 3, a table 302 summarizes the confidence of the top three selected machine learning models across the four different scenarios. Based on the results shown in the table 302, the starting point for the virtual laboratory would be to use either Scenario 1 or Scenario 3 and the selected Machine learning model will be K-Nearest Neighbors. These two Scenarios (1 and 3) provide the highest confidence out of the total 32 machine learning models. However, for practicality purposes, it is much more useful to use Scenario 1 as it requires lower inputs (no inhibitor type or steel type) and can be implemented for all wells irrespective of the service provider contracted for the acid stimulation job.

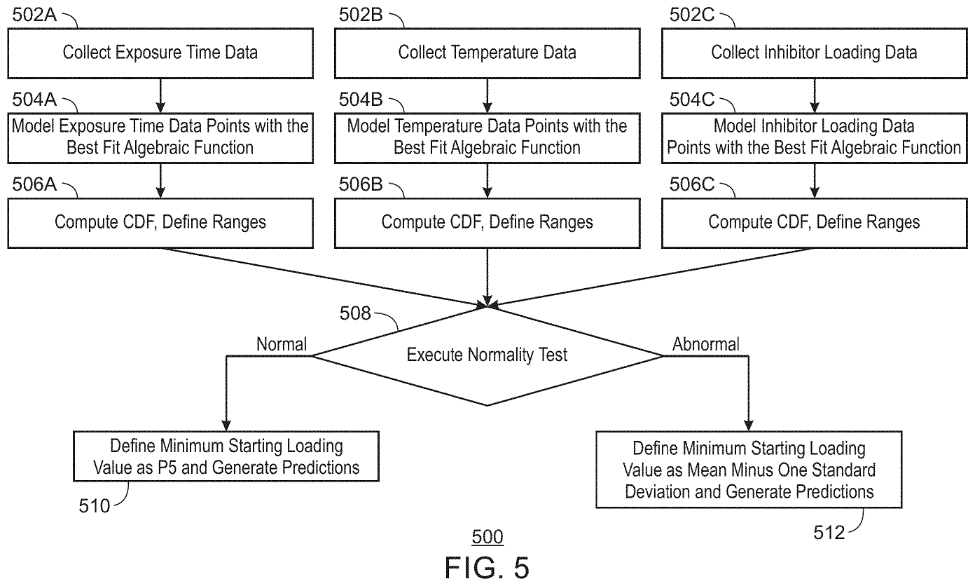

A virtual laboratory enables classification on an acid corrosion inhibitor. In examples, the virtual laboratory includes the selected machine learning model linked to a processing engine to execute the virtual laboratory. In embodiments, the inputs are obtained by a user inputting the required well input data using a graphical user interface (GUI). In embodiments, the inputs are extracted from other data sources. In embodiments, the virtual laboratory outputs an optimum inhibitor loading in gallon per thousand gallons. The input data to the machine learning models is based on the selected scenario. For example, as illustrated in table 108 of FIG. 1, scenario 1 requires acid concentration percentage, exposure time, and downhole well temperature. Then, the virtual laboratory performs iterations based on the machine learning model to predict the optimum loading of the acid corrosion inhibitor. The iterations can be done in either of the process 400 of FIG. 4 or the process 500 of FIG. 5.

FIG. 4 is a process flow diagram of a process 400 for iteratively determining corrosion inhibitor loading based on a predefined minimum corrosion inhibitor loading value. At block 402, iterations are initialized at a predefined minimum loading value, in gallons per thousand gallons. For example, the predefined minimum corrosion inhibitor loading can be 0.5 gallons per thousands. At block 404, a minimum corrosion inhibitor loading is provided as an additional input along with other inputs for the machine learning model (provided by the user). In embodiments, the virtual laboratory (e.g., virtual laboratory 110 of FIG. 1) enables a user to input the minimum corrosion inhibitor value (e.g., inputs 102 of FIG. 1). As described with respect to FIG. 1, the inputs are based on a scenario type. At block 406, a trained machine learning model is used to predict the success or failure of the corrosion inhibitor loading. If the corrosion inhibitor loading is predicted as success, it is provided to the user as the optimum value. Otherwise, the virtual laboratory adds a 0.5 gallons per thousand gallon value to the initial 0.5 predefined minimum loading value and continues the iterations until a success prediction is made.

FIG. 5 is a process flow diagram of a process 500 for iteratively determining corrosion inhibitor loading using statistically significant generated data. Generally, in the process 500, data associated with exposure time, temperature, and inhibitor loading is generated. Each of the data associated with exposure time, temperature, and inhibitor loading are modeled and a best fit model is determined for each dataset, respectively. An inhibitor loading cumulative distribution function is generated using the best fit models. Success or failure of the inhibitor loading values are based on the inhibitor loading cumulative distribution function.

In operation, a trained machine learning model using process 500 begins with a predefined minimum loading value, in gallons per thousand gallons. The virtual laboratory using process 500 provides statistically significant inputs to the trained machine learning model, where the inputs are provided by the user according to the scenario to predict the virtual laboratory test success or failure output. The underlying computational iterations are dependent on the statistical significance of the input and output variables. To ensure that the input and output variables are statistically significant, the statistically significant inputs are generated according to the process 500. In embodiments, the virtual laboratory (e.g., virtual laboratory 110 of FIG. 1) generates statistically significant inputs (e.g., inputs 102 of FIG. 1).

In particular, at block 502A statistically significant inputs are generated by obtaining the exposure time data from actual laboratory tests. Each data point is plotted against its percentile value. At block 504A, the generated data points are modeled with the best-fit algebraic function (mostly polynomial) using linear regression. The best-fit model will have the maximum R² value and the least average absolute error. At block 506A, the generated best-fit model is used to compute the cumulative distribution function and define P₁₀, P₂₅, P₅₀, P₇₅ and P₉₀ values as illustrated in table 304 of FIG. 3. In examples, using the computed exposure time percentiles, ranges as described in table 304 of FIG. 3 are defined, where i is the exposure time range identifier.

Next, temperature data is obtained from actual laboratory tests at block 502B and each data point is plotted against its percentile value. The generated data points are modeled with the best-fit algebraic function (mostly polynomial) using linear regression at block 504B. The best-fit model will have the maximum R² value and the least average absolute error. The generated best-fit model is used to compute the Cumulative Distribution Function (CDF) and define P₁₀, P₂₅, P₅₀, P₇₅ and P₉₀ values as illustrated in table 306 of FIG. 3. In examples, using the computed temperature percentiles, ranges as described in table 306 of FIG. 3 are defined, where j is defined as the temperature range identifier.

Next, for each acid concentration (typically 15% and 20%), at block 502C inhibitor loading datasets that correspond to possible combinations of exposure time and temperature ranges i.e. D_{i,j} are defined. For example, D_{1,2} is an inhibitor loading dataset that is defined at an exposure time from P₁₀ to P₂₅ and a temperature from P₂₅ to P₅₀. For each D_{i,j}, inhibitor loading data is collected and each data point is plotted against its percentile value. At block 504C the generated data points are modeled with the best-fit algebraic function (mostly polynomial) using linear regression. The best-fit model will have the maximum R² value and the least average absolute error.

At block 506C, the generated best-fit model is used to compute the inhibitor loading cumulative distribution function (CDF). At block 508, a normality test is performed on a semi-log graph to determine whether the data is normally distributed or not.

At block 510, if the inhibitor loading CDF is normal, the optimal loading value is defined as follows. First, a minimum starting loading value is defined as P₅. This value is input to the trained machine learning model all the way to P₉₅, at an increment of 0.1 gallon per thousand gallons, to predict the virtual laboratory test success or failure events. If the machine learning model outcomes are “success,” the optimal loading value will be the minimum loading value. If some of the machine learning model outcomes are “failure,” the optimal loading value will be the maximum loading value corresponding to a “failure” outcome which will ensure a conservative optimal loading recommendation.

At block 512, if the inhibitor loading CDF is not normal (e.g., abnormal), the optimal loading values is defined as follows. First, a minimum starting loading value is defined as the mean value minus one standard deviation of the inhibitor loading data. The trained machine learning model is executed from this value all the way to the mean value plus one standard deviation of the inhibitor loading data, at an increment of 0.1 gallon per thousand gallons, to predict the virtual laboratory test success or failure events. If the machine learning model outcomes are “success,” the optimal loading value will be the minimum loading value. If some of the machine learning model outcomes are “failure,” the optimal loading value will be the maximum loading value corresponding to a “failure” outcome which will ensure a conservative optimal loading recommendation. Inhibitor loading datasets are iteratively defined and used to obtain a success/failure prediction for all possible combinations of acid concentration, exposure time and temperature.

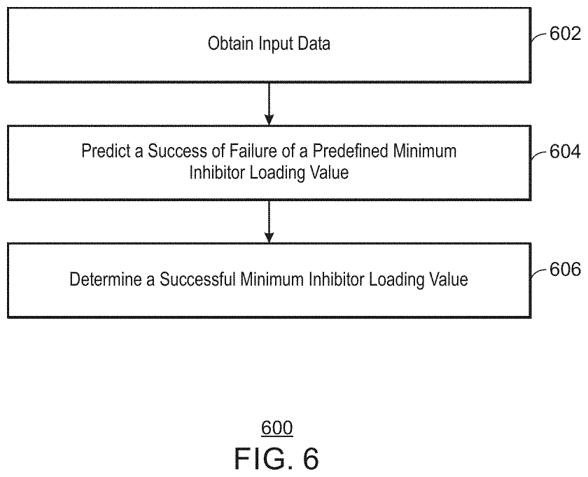

FIG. 6 is a process flow diagram of a process 600 for an acid corrosion inhibitor virtual laboratory (e.g., virtual laboratory 110 of FIG. 1).

At block 602 input data is obtained. The input data comprises at least one of an acid concentration, exposure time, temperature, or any combinations thereof.

At block 604, a success or failure of a predefined minimum inhibitor loading value is predicted. In examples, a success of the minimum inhibitor loading value is metal loss values of less than 0.2 lb/ft2 to be successful for all steel types. In examples, a failure of the minimum inhibitor loading value is a metal loss values that are equal to or more than 0.2 lb/ft2 to be a failure for all steel types. Generally, the success or failure is determined using the process 400 of FIG. 4 or the process 500 of FIG. 5.

At block 606, a minimum inhibitor loading value that is a successful corrosion inhibitor loading is determined based on the inputs responsive to a failure of the predefined minimum inhibitor loading value.

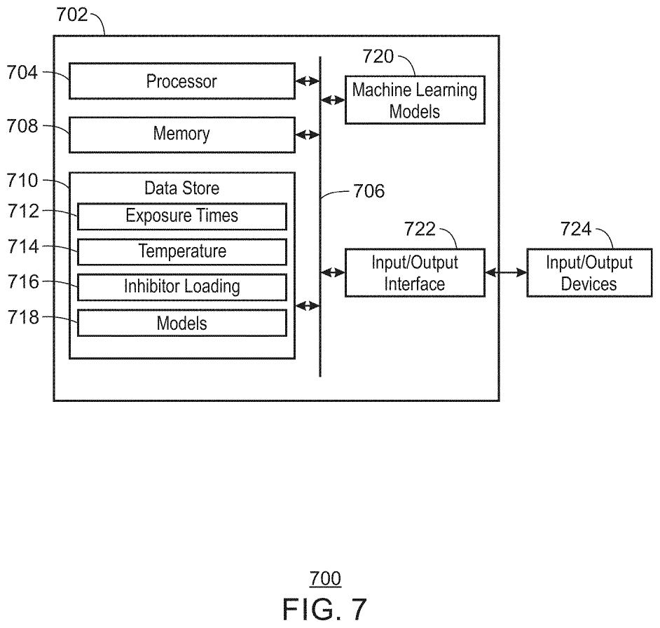

FIG. 7 is a block diagram of a system 700 used for an acid corrosion inhibitor virtual laboratory. The system 700 includes a controller 702. In some embodiments, controller 702 is a microcontroller, for example, mounted in an enclosure communicatively coupled with input/output devices, including sensors, actuators, and the like. In other embodiments, the controller 702 is a virtual controller running on a processor in a distributed computing system, on a virtual processor in a cloud server, or using other real or virtual processors.

The controller 702 includes a processor 704. The processor 704 may be a microprocessor, a multi-core processor, a multithreaded processor, an ultra-low-voltage processor, an embedded processor, or a virtual processor. In some embodiments, the processor 704 may be part of a system-on-a-chip (SoC) in which the processor 704 and the other components of the controller 702 are formed into a single integrated electronics package. In various embodiments, the processor 704 may include processors from Intel® Corporation of Santa Clara, Calif., from Advanced Micro Devices, Inc. (AMD) of Sunnyvale, Calif., or from ARM Holdings, LTD., Of Cambridge, England. Any number of other processors from other suppliers may also be used.

The processor 704 may communicate with other components of the controller 702 over a bus 706. The bus 706 may include any number of technologies, such as industry standard architecture (ISA), extended ISA (EISA), peripheral component interconnect (PCI), peripheral component interconnect extended (PCIx), PCI express (PCIe), or any number of other technologies. The bus 706 may be a proprietary bus, for example, used in an SoC based system. Other bus technologies may be used, in addition to, or instead of, the technologies above.

The bus 706 may couple the processor 704 to a memory 708. In some embodiments, such as in PLCs and other process control units, the memory 708 is integrated with a data store 710 used for long-term storage of programs and data. The memory 708 include any number of volatile and nonvolatile memory devices, such as volatile random-access memory (RAM), static random-access memory (SRAM), flash memory, and the like. In smaller devices, such as PLCs, the memory 708 may include registers associated with the processor itself. The data store 710 is used for the persistent storage of information, such as data, applications, operating systems, and so forth. The data store 710 may be a nonvolatile RAM, a solid-state disk drive, or a flash drive, among others. In some embodiments, the data store 710 will include a hard disk drive, such as a micro hard disk drive, a regular hard disk drive, or an array of hard disk drives, for example, associated with a DCS or a cloud server. In embodiments, the datastore includes the laboratory data such as exposure times 712, temperatures 714, and inhibitor loading 716. Best fit models 718 are also stored in the data store 714. The bus 706 couples the processor 704 to a machine learning models. In embodiments, the machine learning models 720 include several machine learning models trained on these test points (e.g., exposure times 712, temperature 714, and inhibitor loading 716) and later used to predict the optimum corrosion inhibitor loading. The predictions occur, for example, as described with respect to FIGS. 4-6.

The bus 706 couples the processor 704 to an input output interface 722. In input output interface may be coupled with one or more input output devices 724. The input output devices 724 may be, for example, a display, keyboard, mouse, and the like. The input output devices can be used to render a graphical user interface, where the user can input for processing by the virtual laboratory as discussed above.

Other implementations are also within the scope of the following claims.

What is claimed is:

1. A method, comprising:
obtaining, using a processor, inputs comprising at least one of an acid concentration, exposure time, temperature, or any combinations thereof;
predicting, using the processor, a success or failure of a predefined minimum inhibitor loading value;
determining, using the processor, a minimum inhibitor loading value that is a successful corrosion inhibitor loading based on the inputs responsive to a failure of the predefined minimum inhibitor loading value.

2. The method of claim 1, wherein the inputs further comprises a steel type, inhibitor type, a predefined minimum inhibitor loading value, or any combinations thereof.

3. The method of claim 1, wherein the predicting further comprises:
inputting a predefined minimum corrosion inhibitor loading value to a trained machine learning model;
predicting a success or failure of the predefined minimum corrosion inhibitor loading value;
providing the predefined minimum corrosion inhibitor loading value as a final value to a user in response to predicting a success; and
iteratively increasing predefined minimum corrosion inhibitor loading value and predicting success or failure of the increased predefined minimum corrosion inhibitor loading value until a success prediction is provided.

4. The method of claim 1, wherein the predicting further comprises:
generating dataset associated with exposure time, temperature, and inhibitor loading;
applying best fit models to each respective dataset;
generating a cumulative distribution function using the best-fit models; and
predicting success or failure of inhibitor loading values using the cumulative distribution function.

5. The method of claim 4, wherein the inhibitor loading values are statistically significant.

6. The method of claim 1, wherein the inputs are selected according to a corresponding scenario, wherein predicting a success or failure uses a machine learning model is trained based on the corresponding scenario.

7. The method of claim 1, wherein the inputs are entered to the virtual laboratory by a user inputting the required well input data using a graphical user interface (GUI).

8. A system, comprising:
at least one processor, and
at least one non-transitory storage media storing instructions that, when executed by the at least one processor, cause the at least one processor to:
obtain inputs comprising at least one of an acid concentration, exposure time, temperature, or any combinations thereof;
predict a success or failure of a predefined minimum inhibitor loading value; and
determine a minimum inhibitor loading value that is a successful corrosion inhibitor loading based on the inputs responsive to a failure of the predefined minimum inhibitor loading value.

9. The system of claim 8, wherein the inputs further comprises a steel type, inhibitor type, a predefined minimum inhibitor loading value, or any combinations thereof.

10. The system of claim 8, wherein the predicting further comprises:
inputting a predefined minimum corrosion inhibitor loading value to a trained machine learning model;
predicting a success or failure of the predefined minimum corrosion inhibitor loading value;
providing the predefined minimum corrosion inhibitor loading value as a final value to a user in response to predicting a success; and
iteratively increasing predefined minimum corrosion inhibitor loading value and predicting success or failure of the increased predefined minimum corrosion inhibitor loading value until a success prediction is provided.

11. The system of claim 8, wherein the predicting further comprises:
generating dataset associated with exposure time, temperature, and inhibitor loading;
applying best fit models to each respective dataset;
generating a cumulative distribution function using the best-fit models; and
predicting success or failure of inhibitor loading values using the cumulative distribution function.

12. The system of claim 11, wherein the inhibitor loading values are statistically significant.

13. The system of claim 8, wherein the inputs are selected according to a corresponding scenario, wherein predicting a success or failure uses a machine learning model is trained based on the corresponding scenario.

14. The system of claim 8, wherein the inputs are entered to the virtual laboratory by a user inputting the required well input data using a graphical user interface (GUI).

15. At least one non-transitory storage media storing instructions that, when executed by at least one processor, cause the at least one processor to:
obtain inputs comprising at least one of an acid concentration, exposure time, temperature, or any combinations thereof;
predict a success or failure of a predefined minimum inhibitor loading value; and
determine a minimum inhibitor loading value that is a successful corrosion inhibitor loading based on the inputs responsive to a failure of the predefined minimum inhibitor loading value.

16. The storage media of claim 15, wherein the inputs further comprises a steel type, inhibitor type, a predefined minimum inhibitor loading value, or any combinations thereof.

17. The storage media of claim 15, wherein the predicting further comprises:
inputting a predefined minimum corrosion inhibitor loading value to a trained machine learning model;
predicting a success or failure of the predefined minimum corrosion inhibitor loading value;
providing the predefined minimum corrosion inhibitor loading value as a final value to a user in response to predicting a success; and
iteratively increasing predefined minimum corrosion inhibitor loading value and predicting success or failure of the increased predefined minimum corrosion inhibitor loading value until a success prediction is provided.

18. The storage media of claim 15, wherein the predicting further comprises:
generating dataset associated with exposure time, temperature, and inhibitor loading;
applying best fit models to each respective dataset;
generating a cumulative distribution function using the best-fit models; and
predicting success or failure of inhibitor loading values using the cumulative distribution function.

19. The storage media of claim 18, wherein the inhibitor loading values are statistically significant.

20. The storage media of claim 15, wherein the inputs are selected according to a corresponding scenario, wherein predicting a success or failure uses a machine learning model is trained based on the corresponding scenario.
